(19) United States
(12) Patent Application Publication
(10) Pub. No.: US 2008/0247160 A1
(43) Pub. Date: Oct. 9, 2008

(54) PUCK LIGHT WITH MAGNETIC COVER

(75) Inventor: Wen Tao Jiang, Guangzhou City (CN)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Conservation Technology, LLC, Northbrook, IL (US)

(21) Appl. No.: 11/696,484

(22) Filed: Apr. 4, 2007

(51) Int. Cl. B60Q 1/00

(52) U.S. Cl. 362/227; 362/398; 362/458

(57) ABSTRACT

According to one embodiment of the present invention, at least one puck light with a cover and a base magnetically held together is provided. Other embodiments include a cover and a base magnetically held together while the puck light is mounted to the underside of a horizontal surface, and where the magnetic attraction between the cover and base provides for the removal of the cover from the base by hand without a tool. Other embodiments include two differently shaped covers that are interchangeably attachable to the base. Other embodiments include at least one puck light with a cover and a base magnetically held together, and where the puck light projects a shape onto a support surface and perpendicular to the support surface when the puck light is attached to the surface, where the largest dimension of the projected shape is at most four and one-quarter (4¼) inches.

### FIELD OF THE INVENTION

This invention relates generally to lighting apparatuses, and more particularly to lighting apparatuses with magnetically attachable covers.

### BACKGROUND OF THE INVENTION

Lighting apparatuses, for example those used to illuminate cabinetry, frequently operate to provide functional and/or aesthetic illumination. For example, puck lights can functionally illuminate an otherwise darkened area, such as the area below cabinet shelving, and allow users to better see items such as utensils, food containers, or appliances. As another example, puck lights can be installed to aesthetically accent the contours of an object, such as a cabinet or countertop, or provide accent lighting to an otherwise darkened area, such as the top of a tall cabinet.

Frequently, puck lights have a cover attached to a base with a mechanical friction-type fitting. The mechanical fitting is able to hold the cover to the base in various mounting orientations, such as when the puck light is mounted to the underside of a cabinet with the cover “hanging” from the base. However, wear on the mechanical fitting over time, such as after repeated bulb changes, can result in the mechanical fitting becoming too loose or being bent in a way that results in the fitting becoming too tight. If the mechanical fitting becomes loose, the cover can detach from the base during use. If the mechanical fitting becomes excessively tight, the cover can be very difficult to remove from the base. Other mechanical fittings require tools to remove the cover from the base, which increases the amount of time required to remove the cover and can increase the difficulty associated with removing the cover, particularly if the puck light is in a small or otherwise difficult to access space.

Some puck lights have only one type of cover that attaches to a particular base, preventing a user from changing covers to provide a different illumination pattern or provide a different aesthetic appearance of the puck light. Furthermore, puck lights are frequently placed in relatively difficult to access and confined areas, which increases the difficulty involved with replacing bulbs or changing covers. Consequently, there is a need for an improved puck light.

Certain preferred features of the present invention address these and other needs and provide other important advantages.

Some or all of these features may be present in the corresponding independent or dependent claims, but should not be construed to be a limitation unless expressly recited in a particular claim.

### SUMMARY OF THE INVENTION

It is an object of the present invention to provide an improved puck light.

In accordance with an aspect of the present invention, a puck light for connection to a light bulb and mountable to the underside of a horizontal cabinet surface is described. The puck light includes a base for the light bulb, the base including a magnetic portion and an attachment portion, the attachment portion adapted for attachment to the underside of a horizontal support surface. The puck light further including a first cover attachable to the base and including a magnetic portion, the first cover defining a first shape, where at least one of the base magnetic portion and the first cover magnetic portion includes a magnet and the other of the base magnetic portion and the first cover magnetic portion is magnetically attracted to the magnet. Where additionally the base and the first cover are held together by the magnetic attraction between the base magnetic portion and the first cover magnetic portion when the base and the first cover are attached to one another, and where the base and the first cover project a projected shape onto the support surface and perpendicular to the support surface when the base and the first cover are attached to one another, and wherein the largest dimension of the projected shape is at most four and one-quarter (4¼) inches.

In accordance with another aspect of the present invention, a plurality of interconnected puck lights is described, where the plurality of puck lights are as described in the preceding paragraph, and where the plurality of puck lights are electrically interconnected to one another and electrically connected to an electrical power source.

In accordance with still another aspect of the present invention, a method of forming a puck light is described. The method consists of forming a base with a mounting portion and an attaching portion, the mounting portion adapted for mounting to the underside of a horizontal support surface. The method also includes forming a first cover in a first shape, the first cover including an attaching portion, where the first cover is magnetically held to the base when the first cover attaching portion is attached to the base attaching portion. The method further includes forming a second cover in a second shape different from the first shape, the second cover including an attaching portion, where the second cover is magnetically held to the base when the second cover attaching portion is attached to the base attaching portion. Additionally, the method includes forming a puck light by selecting one of the first cover and the second cover and attaching the selected cover and the base.

Further objects, features and advantages of the present invention shall become apparent from the detailed drawings and descriptions provided herein.

Each embodiment described herein is not intended to address every object described herein, and each embodiment does not include each feature described.

### BRIEF DESCRIPTION OF THE DRAWINGS

FIG. 1A is an exploded view of a puck light according to one embodiment of the present invention.

FIG. 1B is a perspective view of the puck light depicted in FIG. 1A assembled.

FIG. 2 is a perspective view of a puck light according to another embodiment of the present invention.

FIG. 3 is a perspective view of a puck light according to yet another embodiment of the present invention.

FIG. 4 is a perspective view of a puck light according to still another embodiment of the present invention.

FIG. 5 is a perspective view of a puck light according to a further embodiment of the present invention.

FIG. 6 is a perspective view of a puck light according to yet a further embodiment of the present invention.

FIG. 7 is a perspective view of a puck light according to still a further embodiment of the present invention.

FIG. 8 is a perspective view of a puck light according to another embodiment of the present invention.

FIG. 9 is a perspective view of a puck light according to yet another embodiment of the present invention.

FIG. 10A is an exploded view of a puck light according to still another embodiment of the present invention.

FIG. 10B is a perspective view of the puck light depicted in FIG. 10A assembled.

FIG. 11 is a perspective view of a puck light according to still another embodiment of the present invention.

FIG. 12 is a perspective view of a puck light according to yet a further embodiment of the present invention.

FIG. 13 is a perspective view of a plurality of puck lights depicted in FIG. 12 connected to a power supply.

### DETAILED DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended, such alterations and further modifications in the illustrated devices, and such further applications of the principles of the invention as illustrated herein being contemplated as would normally occur to one skilled in the art to which the invention relates.

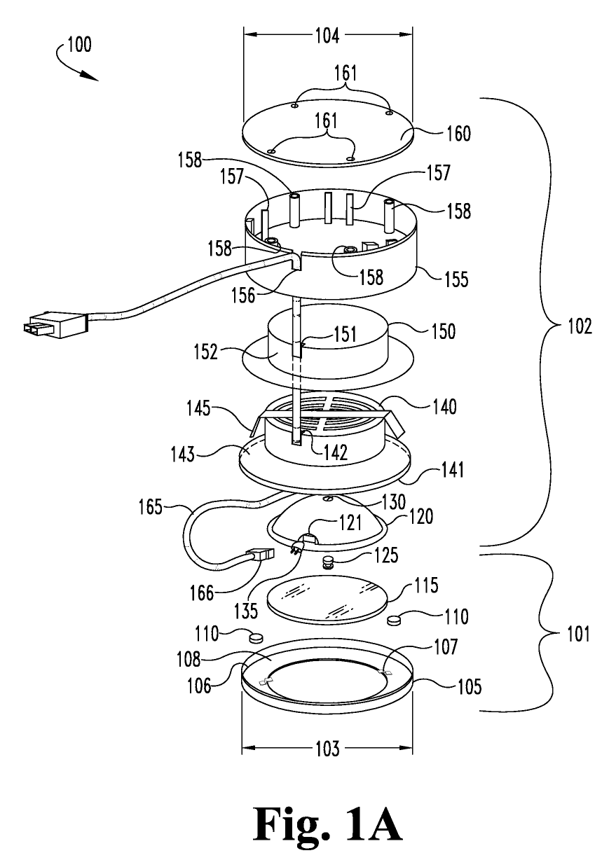

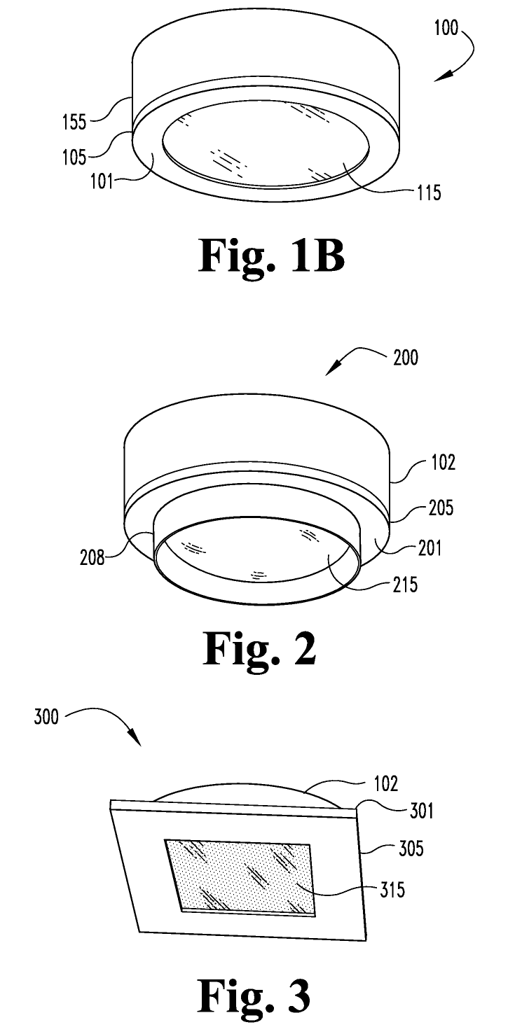

Depicted in FIG. 1A is a light, for example puck light 100, according to an embodiment of the present invention. Puck light 100 includes: a cover, for example cover 101; at least one magnet, for example magnets 110; a base portion, for example base 102; lamp 135; and power cord 165. Cover 101 includes: face plate 105; a lens, for example glass plate 115; and at least one lens connector, for example tabs 107. Base 102 includes: reflector 120; a reflector fastener, for example rivet 125; a reflector fastening portion, for example aperture 130; housing 140; a housing fastener, for example tension clip 145; housing gasket 150; surface collar 155; and mounting gasket 160.

Face plate 105 and housing 140 each include a magnetic portion, magnetic portions 106 and 141, respectively. Magnetic portions 106 and 141 are magnetically coupled when base 102 and cover 101 are connected. The magnetic coupling of magnetic portions 106 and 141 holds face plate 105 and housing 140 together, which holds the cover 101 and the base 102 together. In the illustrated embodiment, magnetic portion 141 includes magnets 110. Magnets 110 are attached to housing 140 by, for example, an adhesive that inhibits removal of magnets 110 from housing 140, including when cover 101 is removed from base 102. Magnetic portion 106 includes a magnetic material that is attracted to magnets 110.

For the purposes of this application, a magnetic material is a material that is magnetically attracted to a common magnet. Non-limiting examples of a common magnet include a bar magnet, a magnet made from a ferromagnetic material, and electromagnets. Non-limiting examples of magnetic materials include steel, iron and common magnets.

For the purposes of this application, a non-magnetic material is a material that is not magnetically attracted to a common magnet. Non-limiting examples of non-magnetic materials include plastic, wood and aluminum.

The magnetic connection between the cover 101 and the base 102 does not wear with repeated use as would a mechanical friction-type fitting. The magnetic connection between magnetic portions 106 and 141 is sufficiently strong to hold cover 101 and base 102 together at least while the assembled puck light 100 is oriented with cover 101 below base 102, such as when the puck light 100 is connected to the underside of a cabinet. However, the magnetic connection between magnetic portions 106 and 141 is such that a user may separate cover 101 from base 102 by hand without using tools.

Glass plate 115 is connected to face plate 105 by a connector, for example tabs 107. Tabs 107 retain glass plate 115 against face plate 105, which provides for the removal of glass plate 115 with face plate 105 when face plate 105 is removed from housing 140.

A reflector fastener connects reflector 120 to housing 140. In the illustrated embodiment, the reflector fastener is a rivet 125, which is inserted through aperture 130 and a complimentary aperture (not depicted) in housing 140. The lamp receptacle 166 of power cord 165 extends through aperture 121 in reflector 120 and is retained therein. Lamp 135 is connected to a lamp receptacle 166, through which lamp 135 receives electrical energy.

Power cord 165 extends through aperture 142 in housing 140, through aperture 151 in housing gasket 150, and through notch 156 in surface collar 155 where it extends away from the puck light 100. When puck light 100 is assembled, aperture 142, aperture 151 and notch 156 align and form a single passageway through housing 140, housing gasket 150 and surface collar 155.

A housing fastener, for example tension clip 145, connects housing 140 to housing gasket 150. Surface collar 155 connects to housing gasket 150, and surface collar 155 surrounds the reduced diameter portion 152 of housing gasket 150. Posts 157 and 158 provide a snug fit between surface collar 155 and reduced diameter portion 152. Mounting gasket 160 connects to the upper portion of surface collar 155 with posts 157 and 158 providing support surfaces for mounting gasket 160. Mounting gasket 160 includes apertures 161 that align with posts 158.

When assembled, puck light 100 is connected to a mounting surface by attachment of surface collar 155 to the mounting surface. Various means of attaching surface collar 155 to the support surface may be used that hold puck light 100 to the support surface, for example, screws, clips, adhesive, nails, magnets and rivets. Frequently, the puck lights 100 are attached to the underside of a horizontal support surface and extend downward therefrom. The means of attaching the puck light 100 to the support surface is sufficiently strong to prevent gravitational forces from pulling the puck light 100 away from the support surface. In the illustrated embodiment, the puck lights 100 are recessed into a hole in the support surface, which hides much of base 102 from view. In other embodiments, puck lights 100 are mounted directly to the support surface without recess.

The diameter 103 of cover 101 is equal to or less than five (5) inches. In particular, the diameter 103 of cover 101 is equal to or less than three (3) inches. In one embodiment, the diameter 103 of cover 101 is approximately two and seven-eights (2⅞) inches (approximately 73 mm), while in an alternate embodiment the diameter 103 of cover 101 is approximately two and three-quarters (2¾) inches (approximately 70 mm).

The diameter 104 of base 102 is equal to the diameter 103 of cover 101 in the illustrated embodiment. However, in alternate embodiments, diameter 104 is not equal to diameter 103. In alternate embodiments, the diameter 104 of base 102 is equal to or less than five (5) inches, and in particular, the diameter 104 of base 102 is equal to or less than three (3) inches. In one embodiment, the diameter 104 of base 102 is approximately two and three-eights (2⅜) inches (approximately 60 mm), while in an alternate embodiment the diameter 104 of base 102 is approximately two and one-quarter (2¼) inches.

When mounted to the support surface, base 102 and cover 101 of puck light 100 project a circular shape onto the support surface and perpendicular to the support surface. The largest dimension of the perpendicular shape projected by puck light 100 onto the support surface is equal to or less than five (5) inches, and in particular equal to or less than three (3) inches. In one embodiment, the largest dimension of the perpendicular shape of puck light 100 is approximately two and seven-eights (2⅞) inches (approximately 73 mm), while in an alternate embodiment the largest dimension of the perpendicular shape of puck light 100 is approximately two and three-quarters (2¾) inches (approximately 70 mm).

Depicted in FIG. 1B is an assembled puck light 100.

It should be appreciated that while the illustrated embodiment depicts magnetic portion 141 as including magnets 110 and magnetic portion 106 as including a metal ring 108, alternate embodiments include different arrangements of at least one magnet and at least one magnetic material provided that the cover is magnetically held to the base with sufficient strength to prevent separation of the cover from the base when the puck light is mounted to a mounting surface, such as when the puck light is mounted with the cover positioned below the base. For example, in an alternate embodiment, magnetic portion 106 is formed of steel, magnetic portion 141 is formed of steel, and at least one magnet 110 is positioned between and holds together the magnetic portions 106 and 141.

As another example, an alternate embodiment includes a magnetic portion 141 formed of steel and face plate 105 constructed of a non-magnetic material with at least one magnet 110 attached. In this alternate embodiment, magnetic portion 106 includes at least one mechanical fastener, such as a clip, bracket or adhesive, that mechanically attaches the at least one magnet 110 to face plate 105. The at least one mechanical fastener retains the at least one magnet 110 with face plate 105 when face plate 105 is removed from housing 140.

Still other embodiments include a magnetic portion 106 formed of steel and housing 140 constructed of a non-magnetic material with at least one magnet 110 attached. In this alternate embodiment, magnetic portion 141 includes at least one mechanical fastener, such as a clip, bracket or adhesive, that mechanically attaches the at least one magnet 110 to housing 140. The at least one mechanical fastener retains the at least one magnet 110 with housing 140 when face plate 105 is removed from housing 140.

In still other embodiments, magnetic portion 106 includes at least one magnet 110 and magnetic portion 141 includes at least one additional magnet 110. One particular embodiment includes magnetic portion 106 with two magnets 110, one magnet 110 with the positive side facing housing 140 and the other magnet with the negative side facing housing 140; and further includes magnetic portion 141 with two magnets 110, one magnet 110 with the positive side facing face plate 105 and the other magnet with the negative side facing face plate 105. With this arrangement of magnets, face plate 105 will not attach to housing 140 if the polarities of the magnets are misaligned, which is useful when a particular orientation between face plate 105 and housing 140 is desired.

Additionally, it should be appreciated that the number of elements forming the base and the cover and the manners in which these elements interconnect are provided for illustrative purposes and are not limiting. For example, alternative embodiments of the present invention include a single piece base mountable to a mounting surface, and to which a cover is magnetically attached.

Although the illustrated embodiment is described as connectable to a mounting surface with screws, alternate embodiments use other fastening means to secure the surface collar 155 to the mounting surface. For example, an alternative embodiment includes magnets for holding base 155 to a mounting surface with magnetic material. Still other embodiments use adhesives or nails to secure surface collar 155 to the mounting surface.

Furthermore, although glass plate 155 is depicted as attaching to face plate 105 with tabs 107, alternative embodiments include different attachment means such as clips or adhesives. Still other embodiments include glass plate 115 attached to and retained with a portion of the base 102, for example housing 140, when face plate 105 is removed from the base 102.

Furthermore, while depicted as an integral part of either housing 140 or face plate 105, alternate embodiments include a portion that is formed of magnetic material separately from face plate 105 and housing 140, and is attached to either face plate 105 or housing 140 by a mechanical fastener, for example a clip, bracket or adhesive. For example, in an alternate embodiment, housing 140 is constructed of a non-magnetic material, and a steel plate is attached to housing 140 with adhesive.

While two magnets 110 are depicted in FIG. 1A, alternate embodiments include one magnet, while still other embodiments include two or more magnets. For example, alternative embodiments include a single magnet attaching one side (“magnetic side”) of face plate 105 to housing 140 and a mechanical fastener attaching the other side (“other side”) of face plate 105 to housing 140. An example mechanical fastener includes a slot and tab arrangement with housing 140 including a tab and face plate 105 including a slot where the slot and tab arrangement acts as a hinge and allows a user to swing the “magnetic side” of face plate 105 away from housing 140 while maintaining the mechanical connection between face plate 105 and housing 140 on the “other side”.

Depicted in FIG. 2 is an assembled puck light 200 according to another embodiment of the present invention. Puck light 200 includes base 102 and cover 201. Cover 201 includes face plate 205 and a lens, for example lenticular glass plate 215. Face plate 205 magnetically attaches to base 102. In the illustrated embodiment, the base of puck light 200 is the same base as depicted in FIGS. 1A and 1B to illustrate the interchangeability of face plates 105 and 205.

Cover 201 further includes a light director, for example shield 208, which manipulates the direction light emanates from puck light 200. Further manipulating the pattern of light emanating from puck light 200 is lenticular plate 215, which includes at least one convex surface. Shield 208 and lenticular glass plate 215 provide a light pattern emanating from puck light 200 different from the light pattern emanating from puck light 100, which is at least useful as a decorative and/or functional alternative to puck light 100.

Depicted in FIG. 3 is a puck light 300 according to yet another embodiment of the present invention. Puck light 300 includes base 102 and cover 301. Cover 301 includes face plate 305 and a lens, for example textured plate 315. In the illustrated embodiment, the base of puck light 300 is the same base depicted in FIGS. 1A, 1B, and 2 and illustrates the interchangeability of covers 101, 201 and 301. Cover 301 magnetically attaches to base 102 at multiple rotational orientations allowing a user to change the orientation of cover 301 with respect to base 102 throughout 360 degrees of rotation. Additionally, textured plate 315 is frosted to emit a different pattern of light from puck light 300 than the patterns emitted from puck lights 100 and 200. In particular, the frosted textured plate 315 tends to disperse light differently than glass plate 115 or lenticular plate 215.

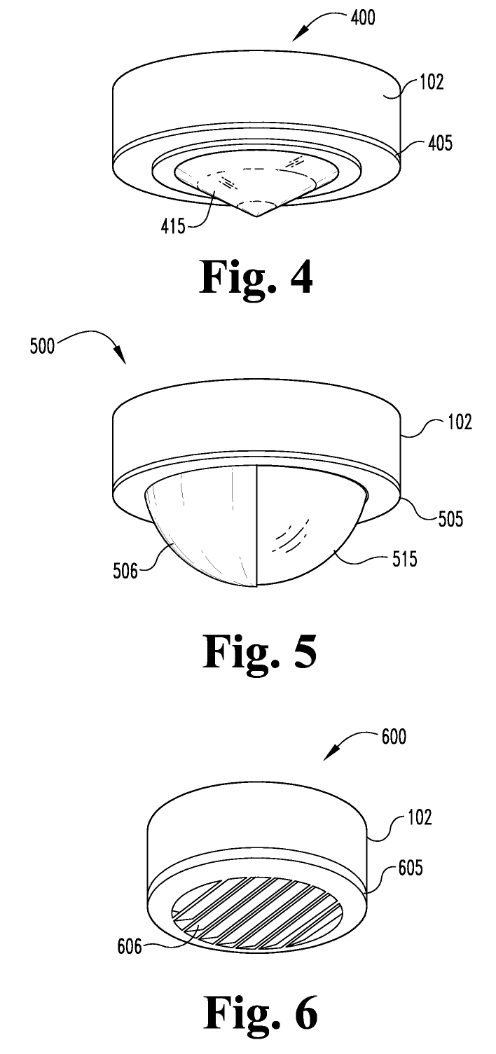

Depicted in FIG. 4 is a puck light 400 according to still another embodiment of the present invention. Puck light 400 includes base 102 and cover 401. Cover 401 includes face plate 405 and a lens, for example conical lens 415. Cover 401 magnetically attaches to base 102 and is interchangeable with covers 101, 201 and 301. Conical lens 415 provides a light pattern emanating from puck light 400 that is still different from the light patterns emanating from puck lights 100, 200 and 300.

Depicted in FIG. 5 is a puck light 500 according to a further embodiment of the present invention. Puck light 500 includes base 102 and cover 501. Cover 501 includes face plate 505, and magnetically attaches to base 102. Cover 501 is interchangeable with covers 101, 201, 301 and 401. Cover 501 further includes a light director, for example shield 506, and a lens, for example, curved glass 515. Cover 501 attaches to base 102 at multiple rotational orientations allowing a user to change the orientation of cover 501 and shield 506 with respect to base 102 throughout 360 degrees of rotation. The light pattern emanating from cover 501 is different still from the light patterns emanating from covers 101, 201, 301 and 401.

Depicted in FIG. 6 is a puck light 600 according to yet a further embodiment of the present invention. Puck light 600 includes base 102 and cover 601. Cover 601 includes face plate 605 and a light director, for example louvers 606. Cover 601 magnetically attaches to base 102 at multiple rotational orientations allowing a user to change the orientation of louvers 606 with respect to base 102 throughout 360 degrees of rotation. The light pattern emanating from cover 601 is different still from the light patterns emanating from covers 101, 201, 301, 401 and 501.

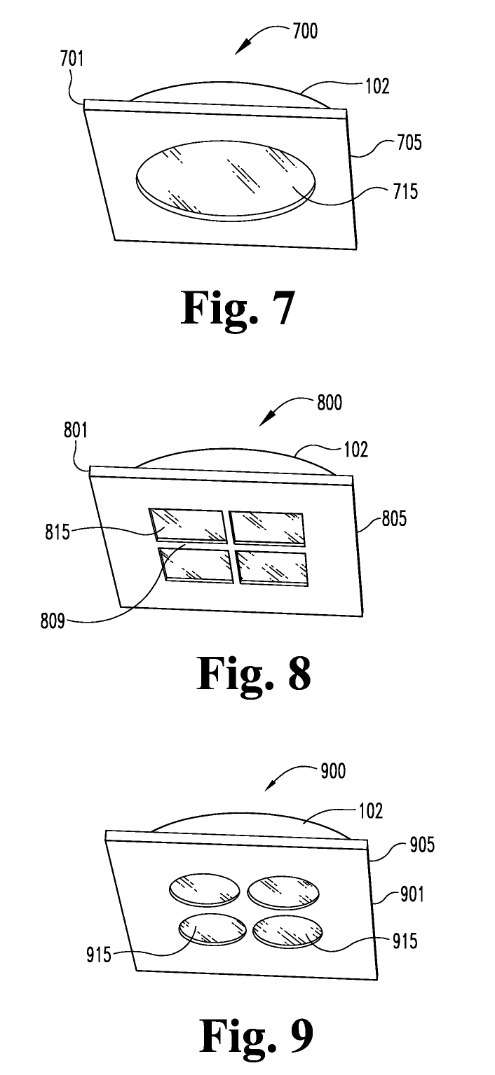

Depicted in FIG. 7 is a puck light 700 according to still a further embodiment of the present invention. Puck light 700 includes base 102 and cover 701. Cover 701 includes face plate 705 and a lens, for example glass plate 715. In the illustrated embodiment, the base of puck light 700 is the same base depicted in FIGS. 1A, 1B, 2, 3, 4, 5 and 6 and illustrates the interchangeability of covers 101, 201, 301, 401, 501, 601 and 701. Cover 701 magnetically attaches to base 102 at multiple rotational orientations allowing a user to change the orientation of cover 701 with respect to base 102.

Depicted in FIG. 8 is a puck light 800 according to still a further embodiment of the present invention. Puck light 800 includes base 102 and cover 801. Cover 801 includes face plate 805 and a lens, for example glass plate 815. Face plate 805 includes grilles 809 that separate glass plate 815 into multiple sections. In the illustrated embodiment, the base of puck light 800 is the same base as depicted in FIGS. 1A, 1B, 2, 3, 4, 5, 6 and 7, and illustrates the interchangeability of covers 101, 201, 301, 401, 501, 601, 701 and 801. Cover 801 magnetically attaches to base 102 at multiple rotational orientations allowing a user to change the orientation of cover 801 with respect to base 102.

Depicted in FIG. 9 is a puck light 900 according to yet a further embodiment of the present invention. Puck light 900 includes base 102 and over 901. Cover 901 includes face plate 905 and a lens, for example glass plate 915. In the illustrated embodiment, the base of puck light 900 is the same base as depicted in FIGS. 1A, 1B, 2, 3, 4, 5, 6, 7 and 8, and illustrates the interchangeability of covers 101, 201, 301, 401, 501, 601, 701, 801 and 901. Cover 901 magnetically attaches to base 102 at multiple rotational orientations allowing a user to change the orientation of cover 901 with respect to base 102.

The ease with which base 102, covers 101, 201, 301, 401, 501, 601, 701, 801 and 901, may be interchangeably attached to base 102 provides a variety of different aesthetic and functional lighting that a user may employ utilizing a single base. This ability to easily interchange different covers is particularly advantageous when a base is attached to a support surface, such as the underside of a kitchen cabinet, and the user desires a different cover.

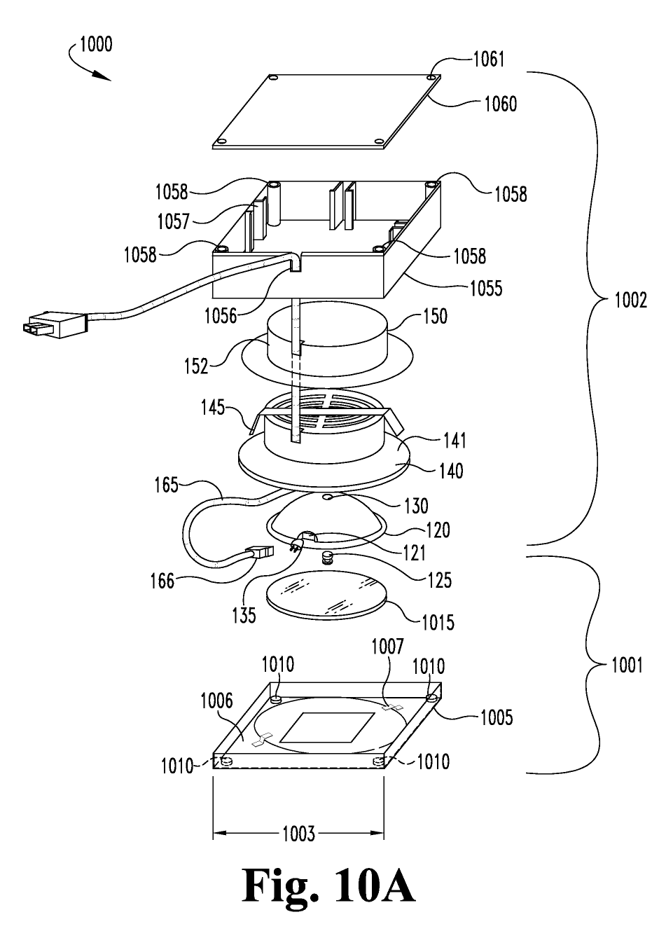

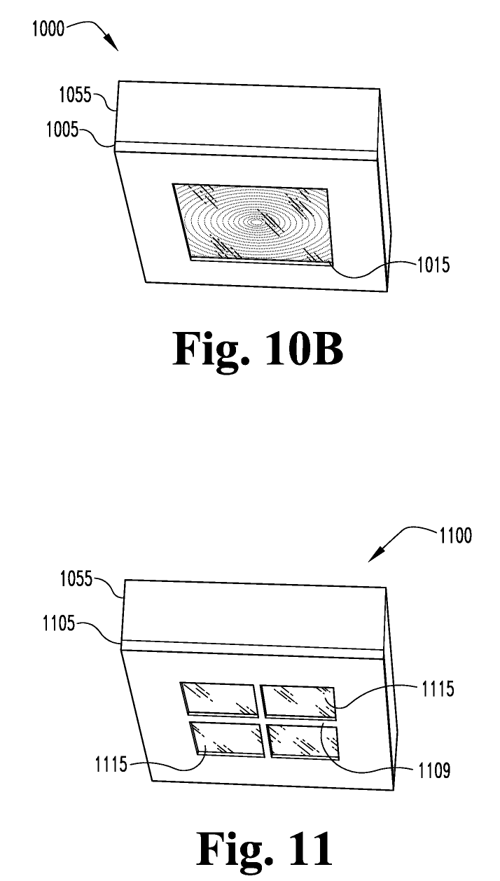

Depicted in FIG. 10A is a light, for example puck light 1000, according to another embodiment of the present invention. Puck light 1000 includes: a cover, for example cover 1001; at least one magnet, for example magnets 1010; a base portion, for example base 1002; lamp 135; and power cord 165. Cover 1001 includes: face plate 1005; a lens, for example glass plate 1015; and at least one lens connector, for example tabs 1007. Base 1002 includes: reflector 120; a reflector fastener, for example rivet 125; a reflector fastening portion, for example aperture 130; housing 140; a housing fastener, for example tension clip 145; housing gasket 150; surface collar 1055; and mounting gasket 1060.

Face plate 1005 and housing 1040 each include a magnetic portion, magnetic portions 1006 and 141, respectively. Magnetic portions 1006 and 141 are magnetically coupled when base 1002 and cover 1001 are connected. The magnetic coupling of magnetic portions 1006 and 141 holds face plate 1005 and housing 140 together, which holds the cover 1001 and the base 1002 together. In the illustrated embodiment, magnetic portion 1006 includes magnets 1010. Magnets 1010 are attached to face plate 1005 by, for example, an adhesive that inhibits removal of magnets 1010 from face plate 1005, including when cover 1001 is removed from base 1002. Magnetic portion 141 includes a magnetic material that is attracted to magnets 1010.

The magnetic connection between the cover 1001 and the base 1002 does not wear with repeated use as would a mechanical friction-type fitting. The magnetic connection between magnetic portions 1006 and 141 is sufficiently strong to hold cover 1001 and base 1002 together at least while the assembled puck light 1000 is oriented with cover 1001 below base 1002, such as when the puck light 1000 is connected to the underside of a cabinet. However, the magnetic connection between magnetic portions 1006 and 141 is such that a user may separate cover 1001 from base 1002 by hand without using tools.

Glass plate 1015 is connected to face plate 1005 by a connector, for example tabs 1007. Tabs 1007 retain glass plate 1015 against face plate 1005, which provides for the removal of glass plate 1015 with face plate 1005 when face plate 1005 is removed from housing 140.

A reflector fastener connects reflector 120 to housing 140. In the illustrated embodiment, the reflector fastener is a rivet 125, which is inserted through aperture 130 and a complimentary aperture (not depicted) in housing 140. The lamp receptacle 166 of power cord 165 extends through aperture 121 in reflector 120 and is retained therein. Lamp 135 is connected to a lamp receptacle 166, through which lamp 135 receives electrical energy.

Power cord 165 extends through aperture 142 in housing 140, through aperture 151 in housing gasket 150, and through notch 156 in surface collar 155 where it extends away from the puck light 100. When puck light 100 is assembled, aperture 142, aperture 151 and notch 156 align and form a single passageway through housing 140, housing gasket 150 and surface collar 155.

A housing fastener, for example tension clip 145, connects housing 140 to housing gasket 150. Surface collar 1055 connects to housing gasket 150, and surface collar 1055 surrounds the reduced diameter portion 152 of housing gasket 150. Posts 1057 provide a snug fit between surface collar 1055 and reduced diameter portion 152. Mounting gasket 1060 connects to the upper portion of surface collar 1055 with posts 1057 and 1058 providing support surfaces for mounting gasket 1060. Mounting gasket 1060 includes apertures 161 that align with posts 1058.

When assembled, puck light 1000 is connected to a mounting surface by attachment of surface collar 1055 to the mounting surface. Various means of attaching surface collar 1055 to the support surface may be used that hold puck light 1000 to the support surface, for example, screws, clips, adhesive, nails, magnets and rivets. Frequently, the puck lights 1000 are attached to the underside of a horizontal support surface extending downwardly therefrom and the means of attaching the puck light 1000 to the support surface is sufficiently strong to prevent gravitational forces from pulling the puck light 1000 away from the support surface. In the illustrated embodiment, screws (not depicted) are retained within posts 1057, extend through apertures 1061, and hold surface collar 1055 to the mounting surface.

The width 1003 of puck light 1000 is equal to or less than five (5) inches. In particular, the width 1003 of puck light 1000 is equal to or less than three (3) inches. More particularly, the width 1003 of puck light 1000 equals approximately two and one-half (2½) inches.

When mounted to the support surface, base 1002 and cover 1001 of puck light 1000 project a square shape onto the support surface and perpendicular to the support surface. The largest dimension of the perpendicular shape of puck light 1000, which is the diagonal length between two corners of cover 1001, is equal to or less than approximately seven (7) inches (the square root of (5²+5²)), and in particular is equal to or less than approximately four and one-quarter (4¼) inches (the square root of (3²+3²)), and more particularly the largest dimension of the perpendicular shape of puck light 100 equals approximately three and one-half (3½) inches (the square root of ((2½)²+(2½)²)).

Depicted in FIG. 10B is an assembled puck light 1000.

Depicted in FIG. 11 is a puck light 1100 according to another embodiment of the present invention. Puck light 1100 includes a cover, for example face plate 1105, a lens, for example glass plate 1115, and a base structure. In the illustrated embodiment, the base structure of puck light 1100 is the same base structure depicted in FIGS. 10A and 10B and illustrates the interchangeability of face plates 1005 and 1105. Face plate 1105 further includes grilles 1109 that divide glass plate 1115 into multiple sections. Face plate 1105 magnetically attaches to surface collar 1055 at different rotational orientations allowing a user to change the orientation of face plate 1105 with respect to surface collar 1055 to one of four orientations, each separated by 90° from the next. Although the usefulness of this feature may be somewhat limited with face plate 1105 being rotationally symmetric at 90° increments, alternate embodiments include covers that are not rotationally symmetric and are connectable to surface collar 1055, for example, covers with lenses and/or light directors similar to those depicted in FIGS. 4, 5 and 6.

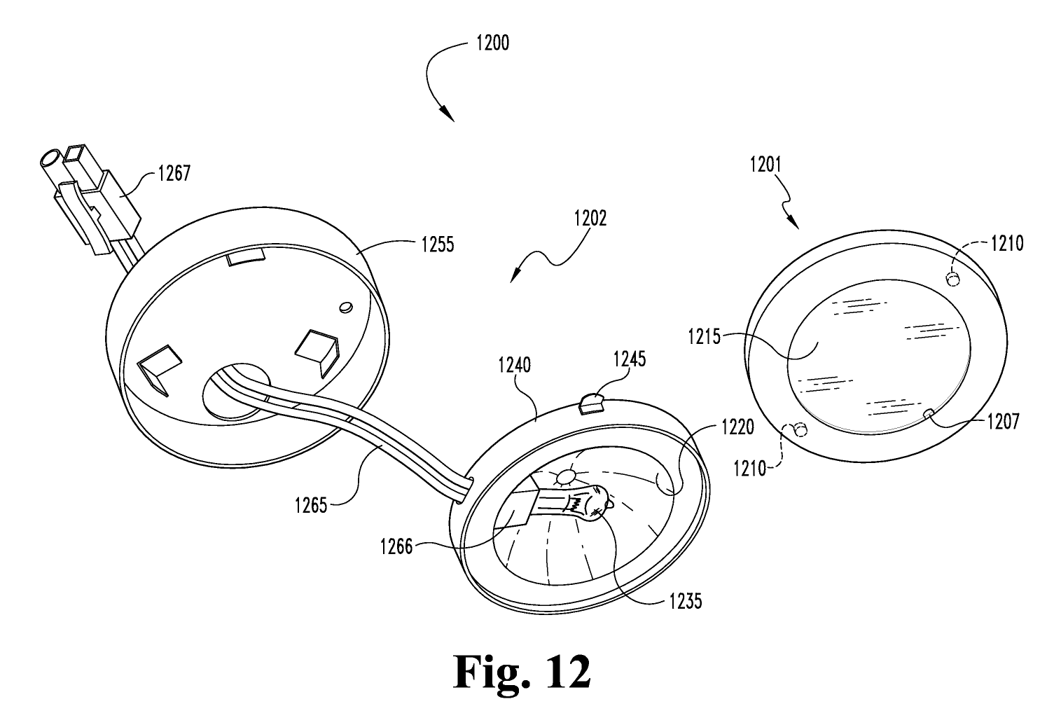

FIG. 12 depicts a puck light 1200 according to still another embodiment of the present invention. Puck light 1200 includes cover 1201, base 1202, light bulb 1235, power cord 1265, light bulb receptacle 1266 and connector 1267. Cover 1201 includes face plate 1205, tabs 1207, magnets 1210 and glass plate 1215. Base 1202 includes housing 1240, and surface collar 1255. Housing 1240 includes reflector 1220 and tabs 1245.

Housing 1240 mechanically attaches to surface collar 1255 with tabs 1245 retaining the connection between housing 1240 and surface collar 1255. Light bulb receptacle 1266 connects to and retains light bulb 1235, and further connects to housing 1240 to maintain the position of and supply power to light bulb 1235. Connector 1267 connects power cord 1265 to a source of electrical power. The magnets 1210 included with cover 1201 are magnetically attracted to housing 1240 and hold cover 1201 and base 1202 together, and tabs 120 connect glass plate 1215 to face plate 1205.

In the illustrated embodiment, light bulbs 1235 are rated to accept twelve (12) volts of electrical potential and sixty (60) watts of electrical power. As such, power supply 1310 supplies twelve (12) volts of electrical potential and at most sixty (60) watts of electrical power to at least one of the plurality of puck lights 1200.

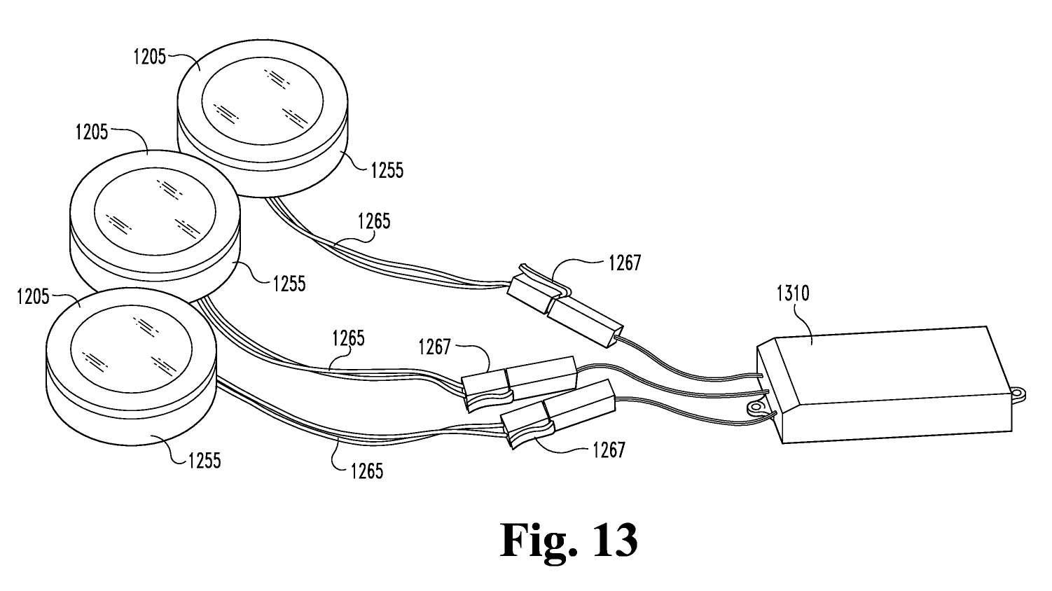

Depicted in FIG. 13 is a plurality of puck lights 1200 connected to an electrical power supply via connectors 1267. The electrical power supply includes a transformer 1310 that receives typical household current and steps the current voltage down to a voltage and current appropriate for the light bulbs 1235. For example, in the depicted embodiment, transformer 1310 delivers approximately 12 volts of electric potential, which is stepped down from typically one hundred twenty (120) volts, and at most sixty (60) watts of electric power. Other embodiments use power supplies that deliver other quantities and forms of electrical energy, provided the other quantities and forms of electrical energy are appropriate for the particular light bulb used with puck lights 1200. For example, alternate embodiments use power supplies that deliver approximately twelve (12) volts and a maximum of twenty (20) watts to the light bulb, while other embodiments use power supplies that deliver approximately one hundred twenty (120) volts and a maximum of sixty (60) watts to the light bulb. Still other embodiments include alternate types of power supply that include, by way of nonlimiting example, batteries, generators, converters, transformers and rectifiers, provided the power supply is appropriate for the light bulbs in use and complies with safety concerns, including safety concerns associated with excess heat generation.

While reference has been made to specific types of connectors and fasteners to mechanically connect different portions of puck light 100, for example tabs 107 and rivet 125, alternate embodiments utilize other fasteners and connectors to provide mechanical securement between subcomponents of puck light 100. Non-limiting examples of other fasteners and connectors include clips, brackets and adhesives.

Although circular and square shapes have been illustrated, alternate embodiments have covers with different geometric shapes. By way of nonlimiting examples, alternate embodiments include covers and bases with triangular, hexagonal, octagonal and irregular shapes.

While example embodiments of the invention have been illustrated and described in detail in the drawings and foregoing description, the same is to be considered as illustrative and not restrictive in character, it being understood that only exemplary embodiments have been shown and described and that all changes and modifications that come within the spirit of the invention are desired to be protected. Dimensions, whether used explicitly or implicitly, are not intended to be limiting and may be altered as would be understood by one of ordinary skill in the art.

1. An improved puck light for connection to a light bulb and mountable to the underside of a horizontal cabinet surface, the puck light including
an outer surface collar adapted for mounting the puck light to the underside surface of a cabinet, and
a base housing for the light bulb, said base housing adapted to optionally
mount inside said outer surface collar, or
flush mount inside a circular hole in the underside of the horizontal cabinet surface,
wherein the improvement comprises:
a magnetic portion of said base housing;
a first cover attachable to said base housing and including both a lens portion and a magnetic portion, said first cover lens portion adapted to permit visible light to pass through said first cover lens portion;
wherein at least one of said base housing magnetic portion and said first cover magnetic portion includes a magnet and the other of said base housing magnetic portion and said first cover magnetic portion is magnetically attracted to said magnet;
wherein said base housing and said first cover are held together by the magnetic attraction between said base housing magnetic portion and said first cover magnetic portion when said base housing and said first cover are attached to one another;
wherein the largest dimension of said base housing is at most four and one-quarter (4 1/4) inches;
wherein said first cover is a non-circular shape; and
wherein said non-circular cover may be magnetically held in place below said cabinet in both said optional mounting of said base: inside said outer surface collar or flush mount inside a circular hole in the underside of the cabinet.

2. The puck light of claim 1, wherein said base magnetic portion includes a magnet.

3. The puck light of claim 1, wherein said first cover magnetic portion includes a magnet.

4. The puck light of claim 1, wherein the largest dimension of said base housing is at most three and one-half (3 1/2) inches across.

5. The puck light of claim 1, wherein the magnetic attraction between said first cover magnetic portion and said base magnetic portion holds said first cover and said base together while the puck light is mounted to the underside of a horizontal support surface.

6. The puck light of claim 5, wherein the magnetic attraction between said first cover magnetic portion and said base magnetic portion provides for the removal of said first cover from said base by hand without a tool.

7-24. (canceled)

25. The puck light of claim 1, wherein said first cover non-circular shape is rectangular.

26. The puck light of claim 25, wherein said first cover non-circular shape is square.

27. The puck light of claim 1, wherein said base housing further includes a tension clip and said outer surface collar further includes a housing gasket, wherein said tension clip is adapted to connect to said housing gasket.
